(19) United States
(12) Patent Application Publication
(10) Pub. No.: US 2004/0051737 A1
(43) Pub. Date: Mar. 18, 2004

(54) Method and system of interface editing and online real-time accessing for a personal mobile device

(76) Inventors: Chung-Chih Lin, Taipei (TW); Wen-Hao Hsu, Taipei (TW); Fu-Bin Peng, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/243,715

(22) Filed: Sep. 16, 2002

(51) Int. Cl. G09G 5/00

(52) U.S. Cl. 345/762

(57) ABSTRACT

The invention provides a method and a system of interface editing and online real-time accessing for a mobile personal device. The system comprises a database, personal mobile device, a database connected to the server, and an interface editing/command setting module. The user can create a new project setting file by the interface-editing/command-setting module then transmit the file to the server. The personal mobile device downloads the needed data for the user and displays the user's personalized layout setting through the connection between the personal mobile device and the server, wherein data transmission can also be wireless data accessing. Therefore, the user can in real-time inquire and update data on-line by using personal mobile device.

### BACKGROUND OF THE INVENTION

1. Field of the Invention

This invention relates to data access. Particularly, the present invention relates to a system and a method of interface editing and online real-time data accessing for a personal mobile device.

2. Description of the Prior Art

As the development of information technologies, people gather more and more data and a variety of information, for storage in a computer. With the analysis and computation of a computer, people can analyze and compute data more easily. By means of various automation process where an operator can access needed information directly through terminal interface and make decisions, old-fashioned time-consuming work can be achieved faster and more accurately.

The terminal interface mentioned above is generally related to a computer device, such as computer, large-scale host, and workstation, which is connected to a server. Due to the disposition of a terminal, a user can't access data anywhere anytime. For example, sales managers who work outside the company fail to provide customers the most updated information, and personnel who can only login on to a particular server are denied access by the computer in different levels of a building. These situations cause an inconvenience for the users to coordinate and respond to the newest data, especially to employees who are frequently on the move.

However, with the development of information technologies, personal mobile devices have become indispensable to people nowadays. Personal mobile devices includes all portable mobile devices, such as cellular phones, personal digital assistants, smart phones, personal organizers, notebooks, etc.

Among the personal mobile devices mentioned above, personal digital assistants, which are a compact and portable device, can store personal data and provide a user with needed functions. Users can install or remove software, which is compatible to the hardware as needed. Furthermore, data synchronization can be achieved by connecting a personal mobile device to a computer.

Accordingly, warehouse employees need to move constantly when inventory. It is more convenient for employee to download and save inventory data into a personal digital assistant instead of checking the inventory data at a particular computer all the time. Using a personal mobile device may dismiss some disadvantages mentioned above. However, due to the saved data within the personal digital assistant can't be used for advanced process, the saved data can't be effectively modified.

### SUMMARY OF THE INVENTION

According to the background of the invention mentioned above, and in accordance with the present invention, a system and a method of interface editing and online real-time data accessing for a personal mobile device is provided, and used to overcome the disadvantages of the prior art.

Accordingly, the object of the present invention is to provide user a graphically designed interface so that user's can personalize a user's interface for a personal mobile device.

Another object is to provide the user a function of interface editing and database accessing without any programming.

Another object is to provide the user with the ability to search matched data and download data to a personal mobile device simultaneously.

Another object is to allow the user to edit data whether the personal mobile device is connected to server or not.

Another object is to provide the user access to update a database via wireless data transmission if any modification exists.

Another object is not only updating the database records, but also real-time updating the field of data representation according to user's need.

According to the objects mentioned above, the present invention provides a system and a method of interface editing and on-line/off-line real-time accessing for a personal mobile device. The present invention comprises a database, a personal mobile device, a server connected to the database, and an interface-editing/command-setting module. The user can create a project-setting file by the interface-editing/command-setting module then transmit the file to the server. The personal mobile device can download the needed data for the user and display the personalized layout setting through the connection between the personal mobile device and the server, wherein the way for transmission can be wireless. Therefore, by using a personal mobile device, the user can in real-time inquire and update data online. The personal mobile device comprises an interface-displaying module that is used to interpret a personalized layout setting within the project-setting file.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is the diagram of the preferred embodiment of the present invention;

FIG. 2 is to illustrate the three main procedures of setting the interface-editing/command-setting module;

FIG. 3A is the flow chart of interface layout setting;

FIG. 3B shows how the user chooses and drags a component for editing interface layout;

FIG. 4 is the flow chart of function key setting and database connection setting;

FIG. 5 is shown the steps of setting database connection in detail;

FIG. 6 is shown the operation procedure of the interface-displaying module; and

FIG. 7 (FIG. 7A+FIG. 7B) is shown the operation procedure between a personal digital assistant and a server.

### DESCRIPTION OF THE PREFERRED EMBODIMENT

Some sample embodiments of the invention will now be described in greater detail. Nevertheless, it should be noted that the present invention can be practiced in a wide range of other embodiments besides those explicitly described, nor is the scope of the present invention expressly limited except as specified in the accompanying claims.

The present invention provides a system and a method of interface editing and online real-time accessing for a personal mobile device. The present invention comprises a database, a personal mobile device, a server connected to the database, and an interface-editing/command-setting module. The user can creates a project-setting file by the interface-editing/command-setting module then transmit the file to the server. The personal mobile device can download the needed data and display the personalized layout setting of the user through the connection between the personal mobile device and the server, wherein the way for transmission can be wireless. Therefore, by using a personal mobile device, the user can in real-time, inquire and update data online.

Furthermore, the personal mobile device has an interface-displaying module that is used to interpret personalized layout setting within the project-setting file. The procedure of interpreting is first to recognize the type of personal mobile device which is being used, then a display template corresponding to the user's personal mobile device is selected for use. Next, is to interpret the interface setting data within the project setting file, and then finally display the user's personalized layout based on the interpreted setting information and display template gained from the previous procedures.

Additionally, as mentioned above, we relate personal mobile devices to a personal digital assistant for a preferred embodiment. It should be noted that the present invention could be practiced in a wide range of other embodiments besides the personal digital assistant.

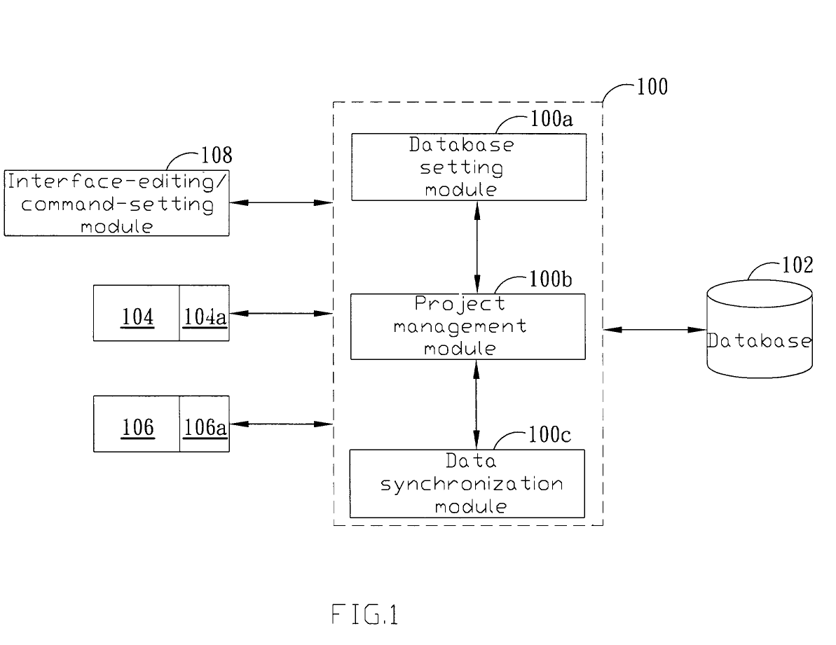

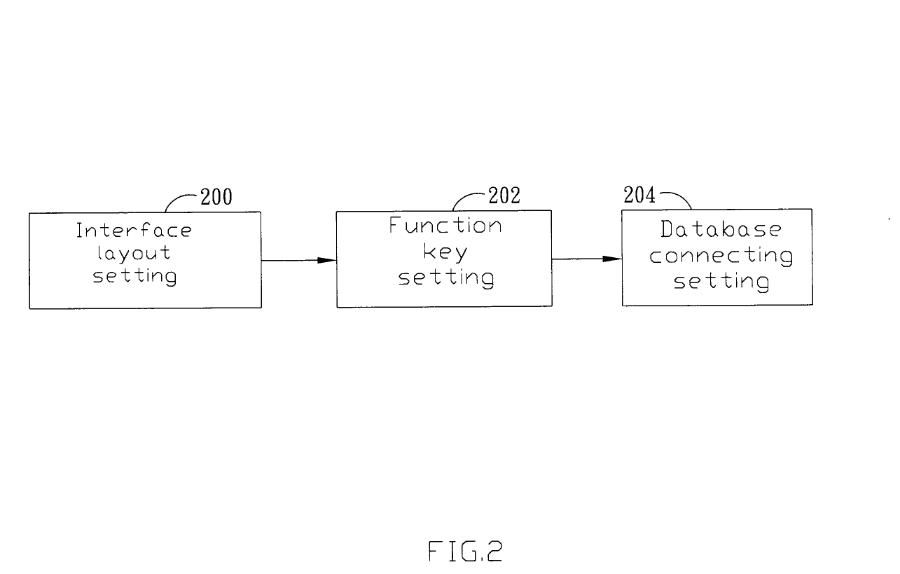

There are several figures used to illustrate the present invention in this preferred embodiment, thus, FIG. 1 is the diagram for system architecture of the present invention. As shown, a server 100 is connected to a database 102, and the server 100 comprises three modules which is a database setting module 100a, project management module 100b, and data synchronization module 100c. The first mobile device 104 is a personal digital assistant, which uses Palm as its operation system, and the second mobile device 106 is a personal digital assistant 106, which uses Win CE as its operation system. The first mobile device 104 and the second mobile device 106 can be data synchronized with server 100 via data synchronization. The first mobile device 104 and the second mobile device 106, both can access data via a wireless connection. Therefore, data transmission between the first mobile device 104 and the second mobile device 106 can be achieved by a wired or wireless connection. The data synchronization mentioned above can also install or remove software inside the personal digital assistant.

User's can create a customized project by interface-editing/command-setting module 108 that can be installed onto a server 100 or any other computers connected to the server 100. The user needs to complete three steps to activate the interface-editing/command-setting module 108. As shown in FIG. 2, the three steps are interface layout setting 200, function key setting 202, and database connecting setting 204. Thereby a new project setting file is created and transmitted to the database setting module 100b within server 100.

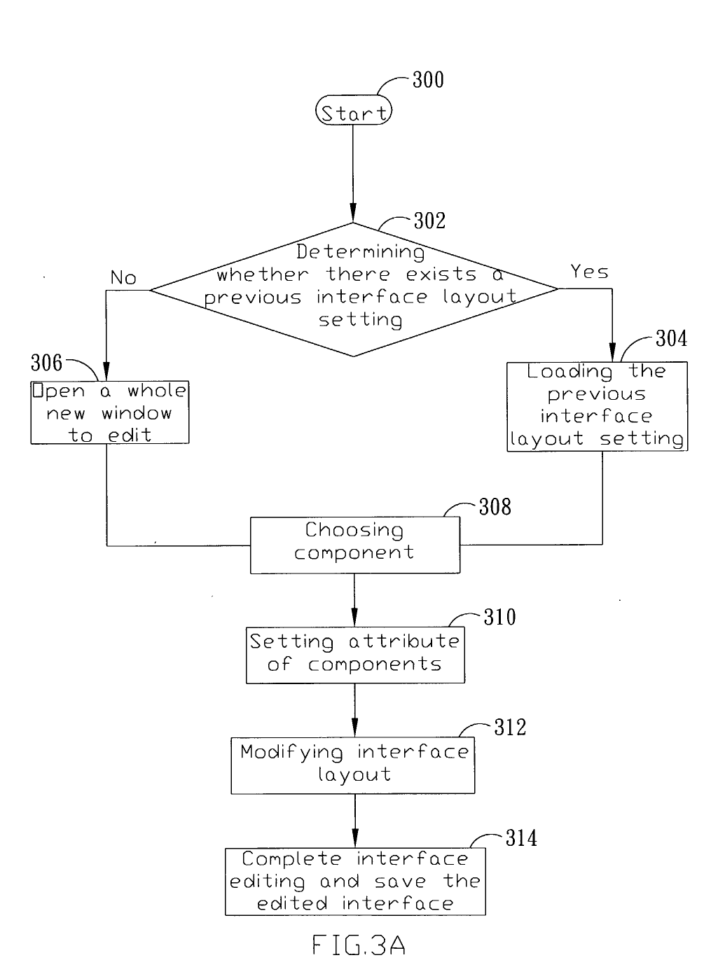

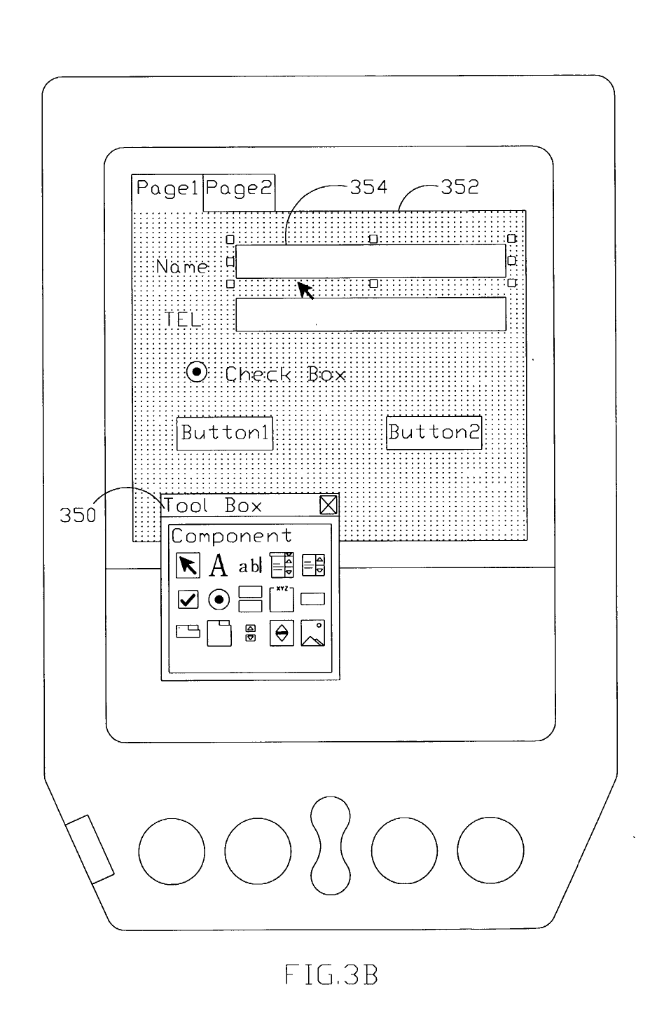

FIG. 3a shows the detail flow chart of the interface layout setting 200 steps. As shown in FIG. 3a, first, starting to set interface layout 300, then determining whether there exists a previous interface layout setting 302 or not. If a previous interface layout setting exits, commence loading the previous interface layout setting 304. Next, choosing a component 308. The user can also open a whole new window to edit 306. Interface-editing/command-setting module 108 provides many graphic components for the user to edit in the needed interface. The components include label, text, combo box, command button, check box, option button, frame, image, and page, and there can be many other components besides those mentioned above.

FIG. 3B shows when the user is doing the foregoing step 308. As shown in FIG. 3B, the user choose a needed component from the tool box 350, and then directly drag it to the interface face layout area 352, for example, the user chooses a text field component 354 then drag it from the tool box 350 to a appropriate position on the interface face layout area 352.

Next is to set the attribute of component, which means among the chosen component 310, for instance, if the user had label and text component s used in the interface layer setting, the attributes of the label are size, color, and so on, and the attributes of the text component are font type, font size, bold, and so on, accordingly the user have to further set the attributes of the components when them are used in the interface layout. The user can set which components are used for display, which are used for command. The next step is to adjust and move the components' position or shape upon the interface layout 312. The final step is to complete the interface editing and save the edited interface 314.

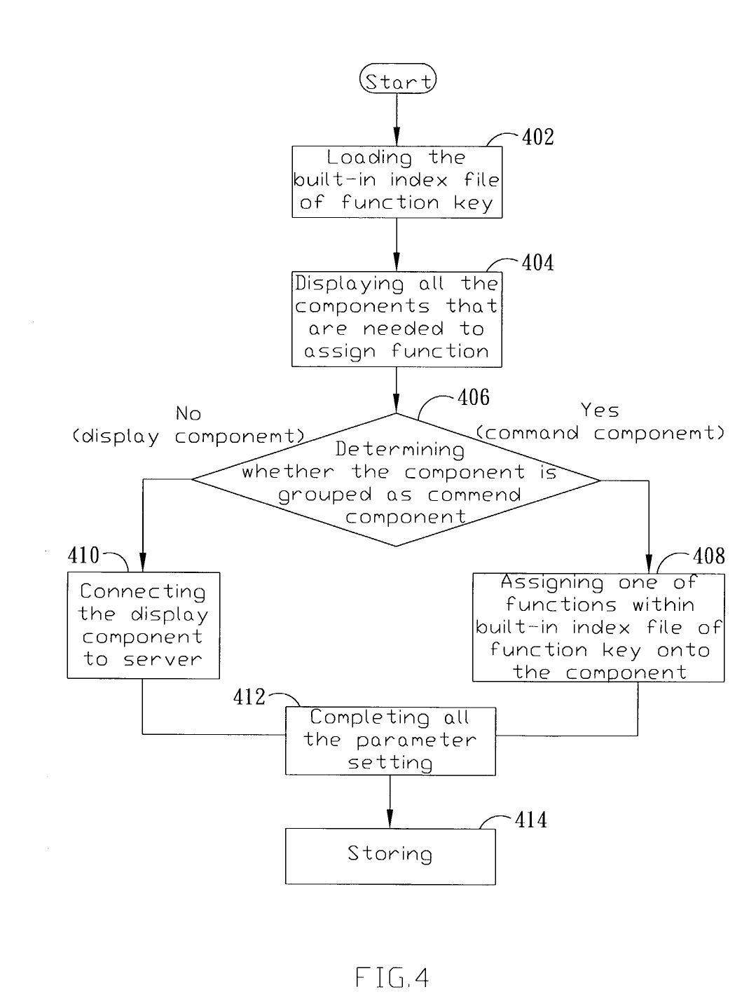

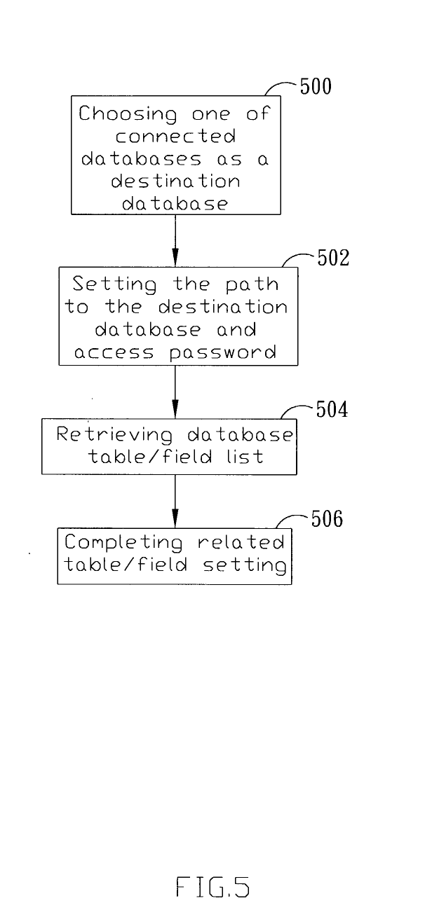

FIG. 4 as shown, is the flow chart of the function key setting 202 and database connection setting 204, which is shown in FIG. 2. When completing the interface editing, the built-in index file of functions key 402 is loaded. The index file of function key shows many built-in functions, such as cancel, delete, save, new record, previous record, next record, download, upload, etc. There can be many other functions besides those mentioned above and the built-in functions mentioned above can be modified based on different embodiment.

Next, check on and display all the components that are needed to assign functions 404. The component can be grouped as a display component that is used for display or command components that are used for action. Then determining whether the component is grouped as the command component or a display component 406. If the component is a command component, assigning one of functions within built-in index file of function key onto the component 408.

If the component is a display component, the user must connect the component to a server 410, wherein user sets the connection between the display component and the matched record within database, so as to display the correct data record on the corresponding display component. Next, completing all the parameter setting 412, then save all the component actions 414.

FIG. 5 shows the steps of setting a database connection. First, choosing one of the connected databases as a destination database 500. Next, the user needs to do some actions on the destination database which includes setting the path to the destination database and access password 502, retrieving database Table/Field list 504 and completing related column setting 506. The user can go back to the previous setting step and modify the setting until the user completes all the settings.

Therefore, when the user completes the three main settings mentioned above, there will be a new project setting file then transmitting the new project setting file to project the management module 100b within the server 100 which is shown in FIG. 1. Next, when the first mobile device 104 which is shown in FIG. 1 and the second mobile device 106 are synchronized with the server 100, data synchronization module 100c will download the corresponding interface setting and function key setting onto the mobile devices simultaneously. After the database setting module processes the corresponding portion of data connection setting within the project setting file, the corresponding portion will be translated into standard database language, such as SQL (Standard Query Language), then transmitted to a database 102. According to the command, database 102 transmits the results to a dada synchronization module 100c, and then the data synchronization module 100c will download the data record onto the mobile device.

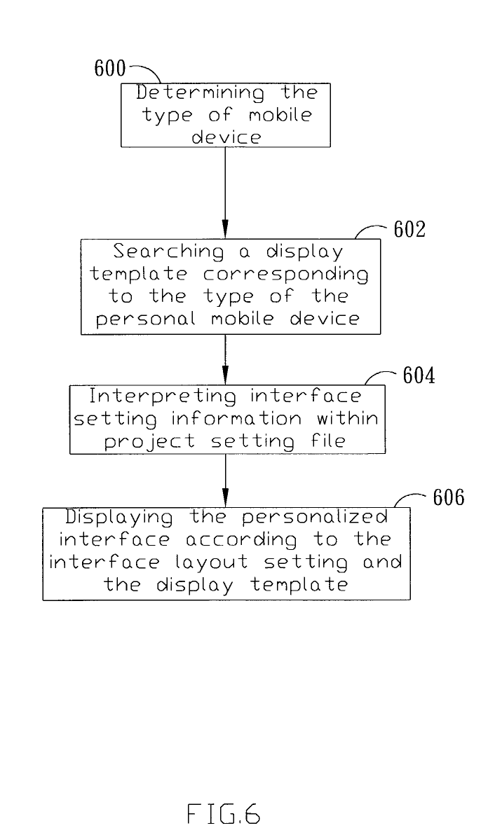

The first mobile device 104 has a first interface-displaying module 104a and the second mobile device 106 has a second interface-displaying module 106a. FIG. 6 shows the operation procedure for an interface-displaying module. First, determining the type of mobile device 600. Next, searching a display template corresponding to the type of the personal mobile device 602, due to the different types of mobile devices, a different format of display template is needed. Interpreting interface setting information within project setting file 604. Finally, according to interpreted data and display template, the operation interface 606 that is edited by the user is correctly shown.

Therefore, the first interface-displaying module 104a is used to interpret interface setting within the project setting file, and enables the correct user operation interface and data to be shown on the first mobile device 104. Though the first mobile device 104 and the second mobile device 106 are personal digital assistants with different operational platforms. The user can apply the previous setting project on the personal digital assistant as long as the personal digital assistant has it's own interface-displaying module.

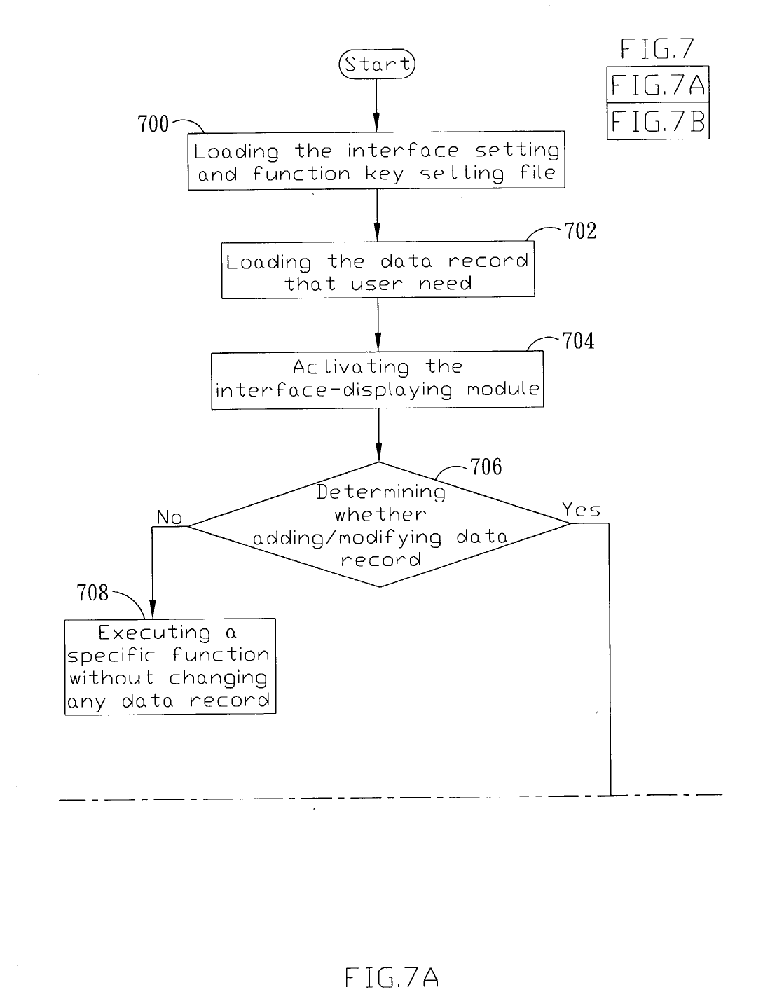

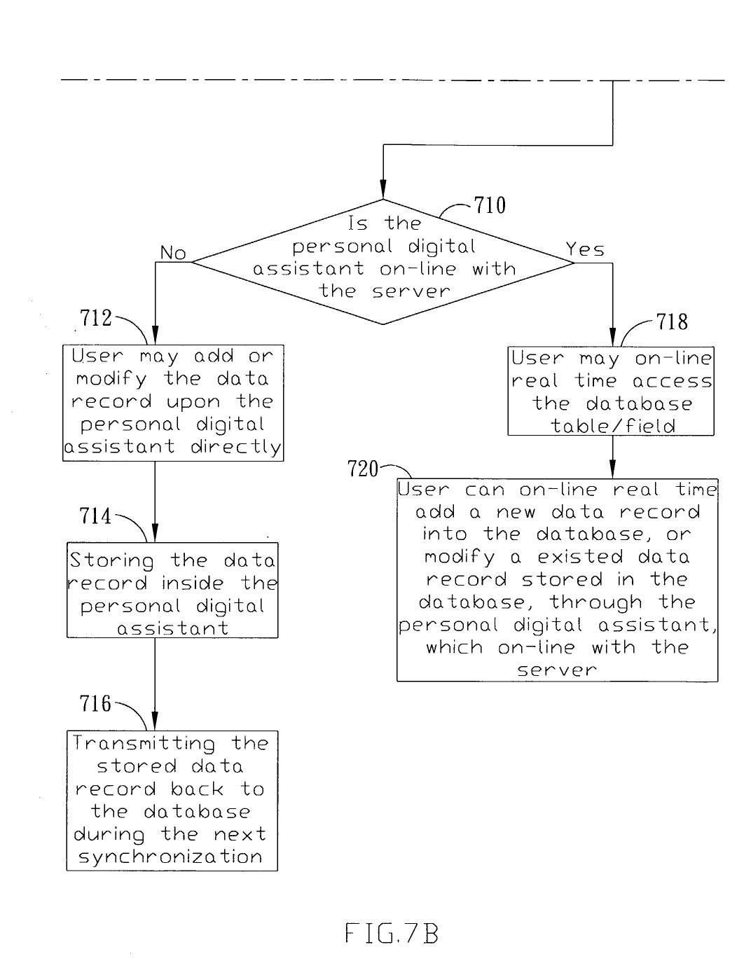

FIG. 7 (FIG. 7A+7B) shows the operational procedure between the personal digital assistant and the server. Before the personal digital assistant data synchronizes with the server, the personal digital assistant downloads the interface setting and function key setting file 700, then downloads the data record user need 702, next the interface-displaying module mentioned 704 is activated so as to display the layout and operation function correctly. The user must determine whether add/modify data record 706, or just execute a specific function without changing any content in data record 708. If the user decides to add or modify a data record, then according to whether the personal digital assistant is on-line with the server, to proceed the next step 710. When the personal digital assistant is not on-line with the server, the user may add or modify the data record upon the personal digital assistant directly 712, then store the data record inside the personal digital assistant 714, last transmit the stored data record back to the database during the next synchronization 716. In other situation that if the personal digital assistant is on-line with the server, user may on-line real time access the database table/field 718, and user can on-line real time add a new data record into the database, or modify a existed data record stored in the database, through the personal digital assistant, which on-line with the server 720.

Although specific embodiments have been illustrated and described, it will be obvious to those skilled in the art that various modifications may be made without departing from what is intended to be limited solely by the appended claims.

What is claimed is:

1. A system that is used to interface design and on-line data access for a mobile personal device, said system comprising:
a database;
a server, said server which is connected to said database; and
a interface-editing/command-setting module, a user creates a project setting file then transmits said project setting file to said server, said personal mobile device display a personalized interface according to said project setting file through a action of synchronization between said personal mobile device and said server.

2. The system according to claim 1, wherein said interface-editing/command-setting module can be installed onto said server or any computers connected to said server.

3. The system according to claim 1, wherein said project setting file at least includes a personalized interface layout setting, a function key setting, and a database setting.

4. The system according to claim 1, wherein said action of synchronization between said personal mobile device and said server is wireless transmission.

5. The system according to claim 1, wherein said personal mobile device has an interface-displaying module, said interface-displaying module interprets and displays said personalized layout setting according to the type of said personal mobile device.

6. The system according to claim 5, wherein the step of interpreting said interface-displaying module comprising:
determining the type of said personal mobile device;
searching a display template corresponding to said type of said personal mobile device;
parsing a personalized interface layout setting within said project setting file; and
displaying a personalized interface according to said parsed personalized interface layout setting and said display template.

7. The system according to claim 1, wherein said server at least comprises a database setting module, a project management module, and a data synchronization module.

8. The system according to claim 1, wherein the steps of creating said project setting file are comprising:
obtaining usable component list;
selecting a needed layout component for designing a interface layout form said component list;
adjusting the disposition of said interface layout; and
setting the function of said needed layout components.

9. The system according to claim 8, wherein said component list at least comprising:
a action component; and
a display component, said display component is used to display data, wherein the content of data can be changed with the operation of said action component.

10. The system- according to claim 8, wherein said step of setting function for said component includes a behavior setting which defines the action when said component is triggered.

11. The system according to claim 8, wherein said step of setting function for said component includes a connection setting of said needed layout component and said database.

12. The system according to claim 8, wherein said component list is obtained by said server.

13. A method of interface editing for a personal mobile device, said method comprising:
obtaining usable component list;
selecting a needed layout component for designing a interface layout form said component list;
adjusting the disposition of said interface layout; and
setting the function of said needed layout components.

14. The method according to claim 13, wherein said component at least comprising:
a action component; and
a display component, said display component is used to display data, wherein the content of data can be changed with the operation of said action component.

15. The method according to claim 13, wherein said step of setting function for said component includes a behavior setting which defines the action when said component is triggered.

16. The method according to claim 13, wherein said step of setting function for said component includes a connection setting of said needed layout component and a database.

17. The method according to claim 13, wherein said component list is obtained by connection of said personal mobile device and a server.
